(19) United States
(12) Patent Application Publication
(10) Pub. No.: US 2004/0051067 A1
(43) Pub. Date: Mar. 18, 2004

(54) Pressurized valve actuator

(76) Inventors: Mahoro M. Fujita, Fairport, NY (US); Todd P. Geib, Fairport, NY (US); Geoffrey J. Scott, Fairport, NY (US); Mark A. Reeves, Hamlin, NY (US)

Correspondence Address: Delphi Technologies, Inc., Mail Code 480410202, P.O. Box 5052, Troy, MI, 48007, US

(21) Appl. No.: 10/241,988

(22) Filed: Sep. 12, 2002

(51) Int. Cl. F16K 31/02

(52) U.S. Cl. 251/129.15

(57) ABSTRACT

In a solenoid-actuated pintle valve assembly, the solenoid assembly is shrouded by a manifold jacket connected via an opening to a source of air at a pressure higher than the working gas pressure within the valve chamber. During operation of the valve and solenoid assembly, a low mass flow of air is forced continuously throughout the solenoid assembly and exits through any leaks in the jacket and along the bushing bores into the valve chamber. Thus, the bushing bore and solenoid assembly are actively protected against entry of contaminants. Further, since it is no longer necessary to vent the valve to permit the escape of gases leaking along the bushing bores, contaminant-laden gases are kept from being exhausted into the engine compartment and from leaving a carbon track residue. The invention is especially useful for exhaust gas recirculation valves on internal combustion engines.

### TECHNICAL FIELD

The present invention relates to pintle valves; more particularly, to exhaust gas recirculation (EGR) pintle valves for internal combustion engines; and most particularly, to apparatus and method for preventing entry of exhaust gas components and external contaminants into a valve's shaft bushing and solenoid actuator.

### BACKGROUND OF THE INVENTION

Pintle valves are well known for use in controlling flow of fluids, and especially gases. Some applications can expose a valve's internal surfaces and moving parts to fouling materials; for example, a pintle-type exhaust gas recirculation valve is exposed to corrosive and carbon-bearing materials which can seep into the clearance between the valve pintle shaft and the pintle bushing. Such materials can deposit as undesirable coking on the shaft, but can also pass through the bushing and enter the solenoid actuator where they can cause impairment or failure of the actuator. Typically, a space exists between the valve body and the actuator, which space may be vented to permit escape of gases leaking along the bushing. However, such vents may also permit ingress of external contaminants, especially water when a valve is subjected to intense spray or temporary immersion. These contaminants may then be drawn into the actuator and also cause mechanical and/or electrical failure of the device. In addition, traces of gases escaping through the vents, laden with coke deposits and other sootlike contaminants, are exhausted into the engine compartment leaving undesireable carbon tracks on surfaces near the vents.

What is needed in the art is a means for keeping gas-borne contaminants from reaching bearing surfaces of a valve pintle shaft and its support bushing, from reaching entry points on an associated solenoid actuator, and from being exhausted into the engine compartment and deposited outside the valve. Also needed in the art is a means for preventing contaminants in the outside environment, such as dirt and water, from entering the actuator.

It is a principal object of the present invention to increase the reliability of an exhaust gas recirculation valve by preventing contaminating materials from passing through the valve bushing, from entering the solenoid actuator, and from being exhausted into the engine compartment and deposited outside the valve. Another object is to inhibit the entry of other outside contaminants into the solenoid actuator.

### SUMMARY OF THE INVENTION

Briefly described, in a solenoid-actuated pintle valve, the solenoid assembly is shrouded by a substantially air-tight jacket connected to a source of air at a pressure higher than the working gas pressure within the valve chamber. During operation of the valve and solenoid assembly, a low mass flow of air is forced continuously throughout the solenoid assembly and exits through any leaks in the jacket and along the bushing bore into the valve chamber. Thus, the bushing bore and solenoid assembly are actively protected against entry of contaminants such as dirt and water from the outside environment and contaminated gases from the engine. Further, since it is no longer necessary to vent the valve to permit the escape of gases leaking along the bushing bore, contaminant-laden gases are kept from being exhausted into the engine compartment and from leaving a carbon track residue.

### BRIEF DESCRIPTION OF THE DRAWINGS

The present invention will now be described, by way of example, with reference to the accompanying drawings, in which:

FIG. 1 is an elevational cross-sectional view of a pintle-type valve in accordance with the invention.

### DESCRIPTION OF THE PREFERRED EMBODIMENTS

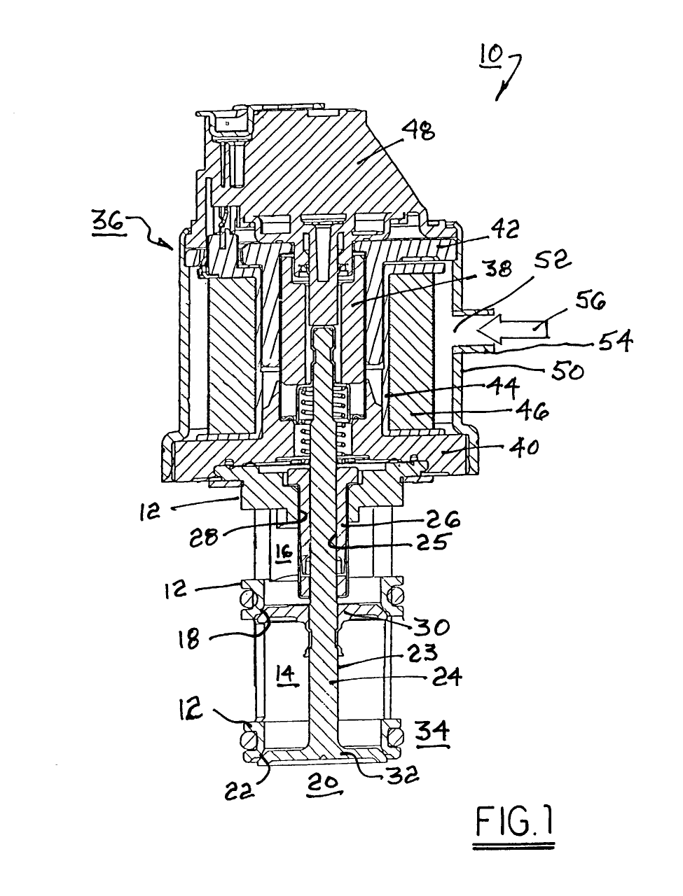

Referring to FIG. 1, a pintle-type valve assembly 10 in accordance with the invention includes a valve body 12 comprising a first annular chamber 14 and a second annular chamber 16 separated by a first annular valve seat 18. Chamber 14 is separated from the exterior 20 by a second annular valve seat 22. A pintle shaft 24 having a surface 23 is slidably disposed in first axial bore 25 in bushing 26 which is mounted in a second axial bore 28 in valve body 12. First valve head 30 is fixedly attached to shaft 24 for axial movement therewith and is matable with first valve seat 18 to regulate flow across seat 18 in known fashion. Second valve head 32 is integral with shaft 24 and is matable with second valve seat 22 for regulating flow across seat 22 in known fashion, in concert with first head 30 and first seat 18. For purposes of discussion of the invention, second seat 22 and second head 32 need not be considered further hereinafter.

Pintle shaft 24 extends from bushing 26 into solenoid actuator assembly 36 attached to valve body 12, which assembly comprises an armature 38, first pole piece 40, second pole piece 42, spool 44, windings 46, and connector cap 48. A housing 50 surrounds the electromechanical elements.

A pintle valve assembly such as valve assembly 10 may be mounted on an internal combustion engine 34 for use as an exhaust gas recirculation valve in known fashion. In such use, chambers 14 and 16 are fully exposed to engine exhaust gases. The object of the invention is to provide apparatus and method for preventing exhaust gas from leaking from chamber 16 along bores 25 and 28 and thence into actuator assembly 36, and for preventing dirt and water and other contaminants from the outside environment from entering the actuator assembly as well. This object is achieved by pressurizing the internal reaches of the actuator assembly to a pressure level exceeding the operating pressure in chamber 16, to forestall passage of exhaust gas along bores 25 and 28. Of course, pressurized gas may be introduced to equal effect anywhere within assembly 10 above the outer end of bushing 26.

Housing 50 defines a manifold jacket for assembly 36 and is formed having an opening 52, preferably provided with hose-attachment means such as nipple 54, which is connected to any suitable source 56 of pressurized gas, preferably air. Such sources may include, among others, a mechanical air pump, a supercharger, and an engine intake turbocharger. Exhaust pressure in chamber 16 is typically about 140 kPa or less, so the source must deliver gas at a pressure higher than 140 kPa. Gas entering the solenoid assembly via opening 52 flows through all the internal clearances between components, helping to cool the assembly, and has access to bores 25 and 28 along which it flows into chamber 16. Thus, exhaust gas is prevented from flowing along those bores and entering solenoid assembly 36. Further, pressurized gas flows continuously from any tiny leaks in housing 50 or its connection to first pole piece 40 and connector cap 48, thus preventing entrance of external contaminants such as dirt or water to which the valve assembly may be exposed during use.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A pintle type valve for use as an EGR valve, comprising:
a) valve means;
b) actuator means attached to said valve means;
c) a manifold jacket surrounding said actuator means for receiving pressurized gas from a source and distributing said gas into said actuator means adjacent said valve means.

2. A pintle type valve in accordance with claim 1 wherein said gas is further distributed from said actuator means into said valve means.

3. A pintle type valve in accordance with claim 1 wherein said valve means contains exhaust gas at a first pressure and said pressurized gas is at a second pressure greater than said first pressure.

4. A pintle type valve in accordance with claim 3 wherein said second pressure is greater than about 140 kPa.

5. A pintle type valve in accordance with claim 1 wherein said actuator means includes an electric solenoid.

6. A pintle type valve for use as an EGR valve, comprising:
a) valve means having a pintle bushing and pintle shaft exposed through a wall thereof; and
b) means for providing pressurized air to said bushing and shaft to prevent leakage of gas from within said valve means, said valve means containing gas at a first pressure and said pressurized gas being at a second pressure greater than said first pressure.

7. An internal combustion engine, comprising a pintle-type exhaust gas recirculation valve having
valve means,
actuator means attached to said valve means, and
a manifold jacket surrounding said actuator means for receiving pressurized gas from a source and distributing said gas into said actuator means adjacent said valve means, said valve means containing exhaust gas at a first pressure and said pressurized gas being at a second pressure greater than said first pressure.

8. A method for preventing ingress of external contaminants into actuator means having pintle type valve means connected thereto, a comprising the steps of:
a) providing a manifold jacket around said actuator means; and
b) flowing air under pressure into said manifold jacket for distribution into said actuator means.

9. A method in accordance with claim 8 further comprising the step of flowing said air under pressure from said actuator means into said valve means.

10. A method in accordance with claim 9 wherein said valve means contains exhaust gas at a first pressure, further comprising the step of providing said pressurized gas at a second pressure greater than said first pressure.
